(19) United States
(12) Patent Application Publication
(10) Pub. No.: US 2025/0136079 A1
(43) Pub. Date: May 1, 2025

(54) METHOD FOR SETTING AN APPLICATION PRESSURE OF A VEHICLE BRAKE AND ASSOCIATED VEHICLE BRAKE

(71) Applicant: ZF CV Systems Global GmbH, Bern (CH)

(72) Inventors: Johannes Heseding, Hannover (DE); Uwe Bensch, Hannover (DE); Thomas Dieckmann, Pattensen (DE)

(21) Appl. No.: 19/009,716

(22) Filed: Jan. 3, 2025

Related U.S. Application Data
(63) Continuation of application No. PCT/EP2023/064958, filed on Jun. 5, 2023.

(30) Foreign Application Priority Data
Jul. 4, 2022 (DE) 10 2022 116 576.0

(51) Int. Cl. B60T 17/22

(52) U.S. Cl. CPC B60T 17/222; B60T 2270/88

(57) ABSTRACT

A method for setting an application pressure of a vehicle brake of a motor vehicle having a commercial vehicle disk brake, wherein, as the brake pressure increases in a first pressure range, the vehicle brake feeds in a brake pad by a brake infeed travel in the direction of the brake disk, crossing a release clearance, with an increase in a friction torque, and, as the brake pressure increases further in a second pressure range, the brake disk is fed in fully and there is a further increase in the friction torque at the vehicle brake. The method steps detect the brake infeed travel as a function of the brake pressure, identify the first pressure range on the basis of the detected brake infeed travel as a function of brake pressure, set an application pressure of the vehicle brake to a pressure within the first pressure range.

### CROSS-REFERENCE TO RELATED APPLICATIONS

This application is a continuation application of international patent application PCT/EP2023/064958, filed Jun. 5, 2023, designating the United States and claiming priority from German application 10 2022 116 576.0, filed Jul. 4, 2022, and the entire content of both applications is incorporated herein by reference.

### TECHNICAL FIELD

The disclosure relates to a method for setting an application pressure of a vehicle brake of a motor vehicle, in particular a commercial vehicle, having a commercial vehicle disk brake, wherein, as the brake pressure increases in a first pressure range, the vehicle brake feeds in a brake pad by a brake infeed travel in the direction of the brake disk, crossing a release clearance, with an increase in a friction torque, and, as the brake pressure increases further in a second pressure range, the brake disk is fed in fully and there is a further increase in the friction torque at the vehicle brake. The increase in the friction torque also results in an increase in the braking force.

### BACKGROUND

The application pressure is understood to mean the brake pressure which is applied to the brake system when the brake is to be held ready for operation but there is no desire for deceleration. It is typically chosen so that it is just sufficient to overcome the mechanical friction of the brake caliper and to reduce the distance between the brake disk and the brake pad, referred to as the release clearance, almost to zero, while, at the same time however, the brake causes minimal frictional losses. The application pressure is thus subject to the tension between providing the minimum possible brake response times, on the one hand, and generating the minimum possible friction torques, on the other hand.

Methods for setting an application pressure of a vehicle brake are known from the prior art and are based, for example, on parameterizing the application pressure and storing it in a brake control device.

Even though such methods have proven their worth for ensuring an advantageous response behavior by the vehicle brake by the application of the application pressure, it has been observed that, in reality, the application of the application pressure can lead to considerable friction torques and thus braking forces even when no deceleration is demanded and desired. As a result, kinetic energy is lost, and this is then no longer available for recovery. At the same time, wear on the vehicle brake is increased.

### SUMMARY

Given this background, it was an underlying object of the disclosure to further develop a method of the type described at the outset in such a way that the disadvantages identified in the prior art are as far as possible eliminated. In particular, the aim was to specify a method that optimizes the setting of the application pressure on a vehicle brake in order to reduce unwanted friction torques at the brake.

According to the disclosure, the object is achieved in the case of a method of the type stated at the outset by the steps of: detecting the brake infeed travel as a function of the brake pressure, identifying the first pressure range on the basis of the detected brake infeed travel as a function of the brake pressure, setting an application pressure of the vehicle brake to a pressure which is within the first pressure range.

The disclosure makes use of the insight that, in the context of a braking operation performed during vehicle operation, it is possible to detect a relationship between the brake infeed travel and the brake pressure, in particular for each of the wheel brakes individually. From this, a first pressure range is identified, and the application pressure in the first pressure range determined is set. In the first pressure range, the brake pad is fed in by a brake infeed travel in the direction of the brake disks, crossing the release clearance, with an increase in the friction torque. In other words, the release clearance is crossed in the first pressure range, and there is at least partial contact between the brake pad and the brake disk. In the second pressure range, the brake disk is fully fed in, and, as the brake pressure increases, there is a further increase in the friction torque at the vehicle brake.

What is achieved by setting the application pressure in the first pressure range is that the vehicle brake ensures rapid provision of braking force but causes only minimal frictional losses. In contrast to methods known from the prior art, in which the application pressure is merely stored in a fixed parameterized form, the method according to the disclosure allows very much more precise setting of the application pressure while taking into account the actual state of the brake, for example, pad wear and other properties. The efficiency of the vehicle brake is thus improved overall.

The disclosure is developed further by the fact that detection of the brake infeed travel as a function of the brake pressure is performed via a continuous pad wear sensor arranged on the vehicle brake. The vehicle brake preferably has two brake pads, wherein a pad wear sensor is preferably arranged on each vehicle brake.

According to a embodiment, the application pressure is set to a pressure which is in a lower third in relation to a total range width of the first pressure range. The selection of the application pressure in the lower third of the first pressure range has proven particularly suitable for ensuring a rapid braking response, on the one hand, and minimization of frictional losses, on the other.

According to a further development, the application pressure is set to a pressure which is in a middle third in relation to a total range width of the first pressure range. For some types of braking and use cases, it has proven expedient to increase the application pressure relative to the preceding embodiment, and although this is associated with a tendency for higher pad wear, braking response times can be reduced.

According to an alternative embodiment, the application pressure is set to a pressure which is in an upper third in relation to a total range width of the first pressure range. Such setting has proven preferential for some use cases and types of braking. In principle, it is thereby possible to reduce the response time of the brake even further, although this is potentially associated with higher pad wear.

The disclosure is developed further by the fact that checking of the set application pressure is performed during the operation of the vehicle, in particular via at least one test braking operation. In a suitable driving situation, for example, during what is referred to as coasting or freewheeling, it is thus possible, for example, given a knowledge of all other acting force-applying actuators, to apply the application pressure and observe a response by the vehicle. From this, it is possible to determine whether the application pressure provides the desired deceleration and/or wear behavior.

The disclosure is developed further by the fact that the checking of the application pressure is performed with the aid of an electric vehicle drive, in particular by determining a change in the drive power or in a drive torque while a test braking operation is being carried out. In other words, the electric drive can be precisely regulated in such a way that the vehicle movement can be maintained without, for example, changing the topology. From the drive power required for this or the drive torque required for this from the electric drive, it is possible to monitor the real deceleration due to the application pressure and to further optimize the level of the application pressure.

The disclosure has been described above with reference to a method. In a further aspect, the disclosure relates to a control device for a vehicle brake of a commercial vehicle. The disclosure achieves the object described at the outset in respect of the control device by configuring the control device to carry out the method according to one of the above embodiments.

The control device is preferably configured as a dedicated control device or as a central control device. A dedicated control device is understood to mean a control device which is assigned directly to at least one of the vehicle brakes or is arranged thereon. The control device makes use of the same advantages and embodiments as the method according to the disclosure and vice versa. In this respect, attention is drawn to the above explanations and the content thereof is incorporated herewith.

In a third aspect, the disclosure relates to a computer program product. The disclosure achieves the object described at the outset in respect of the computer program product in that the product contains commands that, when they are executed on a computer, cause the computer to form a control unit according to one of the above embodiments and/or to carry out the method according to one of the above embodiments. The computer program product also makes use of the same advantages and embodiments as the method according to the disclosure and the control device according to the disclosure and vice versa. In this respect, attention is drawn to the above explanations and the content thereof is incorporated herewith.

In a fourth aspect, the disclosure relates to a vehicle brake, in particular a commercial vehicle disk brake, having a brake carrier having at least one brake pad receptacle, at least one brake pad, which is guided and supported in such a way that it can be moved axially in the brake pad receptacle, a brake caliper that can be moved axially relative to the brake carrier, and a measuring arrangement, which is configured to detect a brake infeed travel of the vehicle brake as a function of the brake pressure, wherein, as the brake pressure increases in a first pressure range, the vehicle brake feeds in a brake pad by a brake infeed travel in the direction of the brake disk, crossing the release clearance, with an increase in a friction torque, and, as the brake pressure increases further in a second pressure range, the brake disk is fed in fully and there is a further increase in the friction torque at the vehicle brake.

The disclosure achieves the object described at the outset in respect of the vehicle brake in that the vehicle brake is configured to set an application pressure to a pressure which is within the first pressure range. The vehicle brake according to the disclosure is also based on the insight that an application pressure that enables minimization of the frictional losses with a simultaneously rapid provision of braking force by the vehicle brake can be determined and set from the relationship between the brake infeed travel and the brake pressure.

The disclosure is developed further by the fact that the measuring arrangement has a pad wear sensor, which is configured to detect the brake infeed travel of the vehicle brake as a function of the brake pressure.

The application pressure is preferably set to a pressure which is in a lower third in relation to a total range width of the first pressure range. According to an alternative embodiment, the application pressure is set to a pressure which is in a middle third in relation to a total range width of the first pressure range. According to another alternative embodiment, the application pressure is set to a range which is in an upper third in relation to the total width of the first pressure range.

The vehicle brake makes use of the same advantages and embodiments as the method according to the disclosure, the control device according to the disclosure and the computer program product according to the disclosure vice versa. In this respect, attention is drawn to the above explanations and the content thereof is incorporated herewith.

In a further aspect, the disclosure relates to a motor vehicle, in particular a commercial vehicle. The disclosure achieves the object described at the outset in respect of the motor vehicle in that the motor vehicle has at least one vehicle brake, wherein the at least one vehicle brake is configured according to one of the above embodiments.

The motor vehicle makes use of the same advantages and embodiments as the method according to the disclosure, the control device according to the disclosure, the computer program product according to the disclosure and the vehicle brake according to the disclosure and vice versa. In this respect, attention is drawn to the above explanations and the content thereof is incorporated herewith.

### BRIEF DESCRIPTION OF DRAWINGS

The invention will now be described with reference to the drawings wherein:

FIG. 1 shows an embodiment of a motor vehicle according to the disclosure having a vehicle brake according to the disclosure in a schematic view;

FIG. 2 shows a diagram, which shows an illustrative relationship between the brake pressure and the brake infeed travel in the case of a vehicle brake according to the disclosure;

FIG. 3 shows a block diagram of a method for setting an application pressure of a vehicle brake;

FIG. 4 shows a schematic illustration of a control device according to the disclosure; and,

FIG. 5 shows a schematic illustration of a computer program product according to the disclosure.

### DETAILED DESCRIPTION

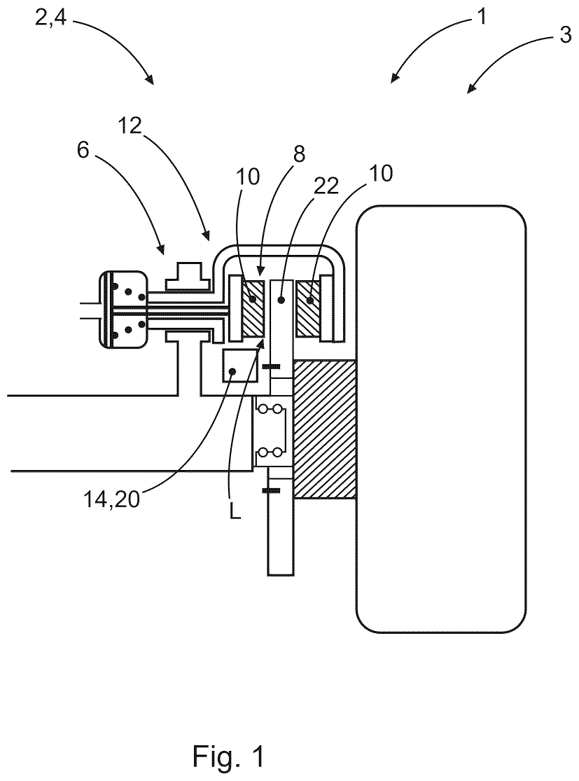

FIG. 1 shows a motor vehicle 1, which is illustrated only schematically here and, in particular, is configured as a commercial vehicle 3. The motor vehicle 1 has a vehicle brake 2. In the present case, the vehicle brake 2 is configured as a commercial vehicle disk brake 4. The vehicle brake 2 has a brake carrier 6. The brake carrier 6 has a brake pad receptacle 8. Two brake pads 10 are arranged in the brake pad receptacle 8, being guided and supported in such a way that they can be moved axially in the brake pad receptacle 8. The vehicle brake 2 furthermore has a brake caliper 12 that can be moved axially relative to the brake carrier 6.

The vehicle brake 2 furthermore has a measuring arrangement 14. The measuring arrangement 14 is configured to detect a brake infeed travel d of the vehicle brake 2 as a function of the brake pressure p. In the state shown in FIG. 1, the vehicle brake 2 has a release clearance L, which describes the distance between the brake disk 22 and the brake pad 10. The measuring arrangement 14 has a pad wear sensor 20. The pad wear sensor 20 is configured to detect the brake infeed travel d of the vehicle brake 2 as a function of the brake pressure p.

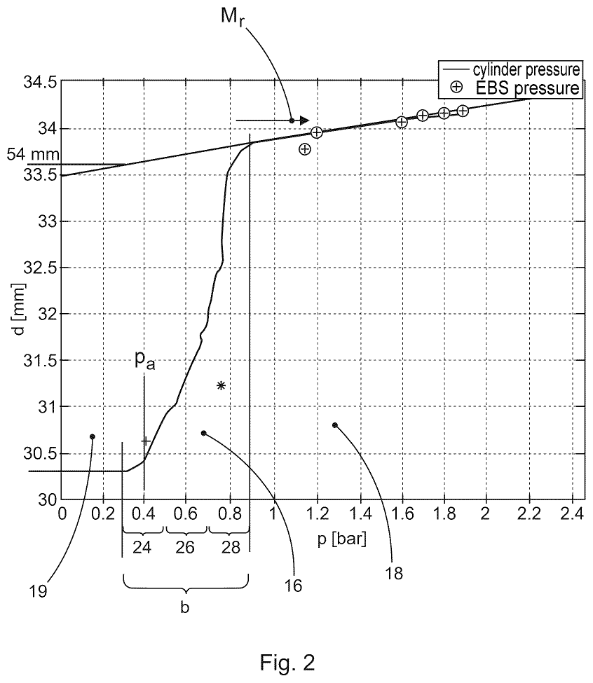

This relationship is illustrated in FIG. 2. FIG. 2 shows an illustrative diagram, in which the brake pressure p is plotted on the abscissa. In FIG. 2, a pressure range for the brake pressure p of 0 bar to about 2.5 bar is plotted. The brake infeed travel d, which is here given in millimeters by way of example, is plotted on the ordinate. Three pressure ranges can be seen in the diagram. As the brake pressure p rises, a static range 19 is reached first of all. In the static range 19, an increase in the brake pressure p does not lead to a change in the brake infeed travel d. In other words, an increase in pressure in this range does not lead to the brake pad 10 being fed in the direction of the brake disk 22. In the example shown in FIG. 2, this static range 19 extends approximately as far as a brake pressure p of 0.3 bar.

If the brake pressure p is increased further, a first pressure range 16 is reached. In this range, as the brake pressure p increases, the release clearance L is crossed and the vehicle brake 2 is fed by a brake infeed travel d in the direction of the brake disk 22, with an increase in a friction torque Mᵣ. At the end of the first pressure range 16, which is reached at about 0.8 bar in the example shown, the brake disk 22 has been fully fed in. If there is a further increase in the brake pressure p, a further increase in the friction torque Mᵣ at the vehicle brake 2 is achieved in the second pressure range 18. In the present case, the first pressure range 16 has a total range width b. This total range width b is divided into a lower third 24, a middle third 26, and an upper third 28.

The vehicle brake 2 is configured to set an application pressure pₐ which is within the first pressure range 16. The application pressure pₐ is preferably set to a pressure pₐ which is in the lower third 24 in relation to the total range width b of the first pressure range 16. This is illustrated schematically in FIG. 2, with the application pressure pₐ here being set to a pressure value of 0.4 bar, for example, this application pressure pₐ being in the lower third 24 of the first pressure range 16. Setting the application pressure pₐ in this range ensures that the vehicle brake 2 can quickly provide a braking force, starting from the relevant standby state, and at the same time that minimal frictional losses occur in this standby state.

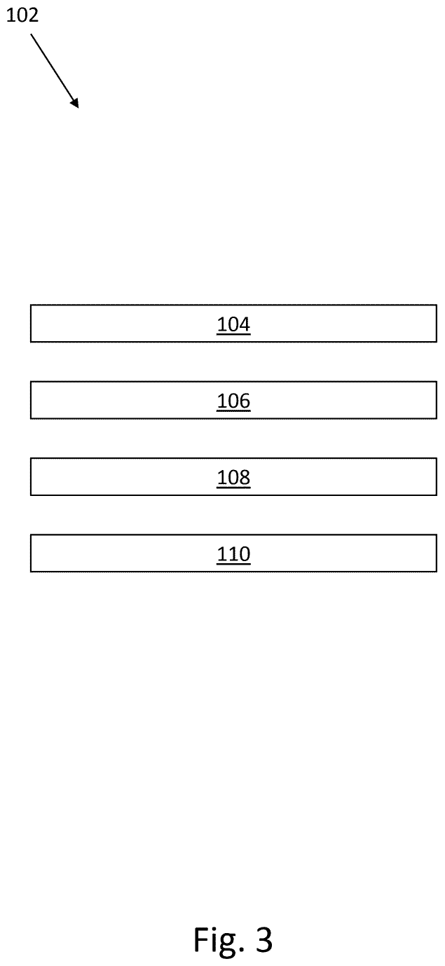

FIG. 3 shows a block diagram of a method according to the disclosure for setting an application pressure pₐ of a vehicle brake 2 of a motor vehicle 1, in particular a commercial vehicle disk brake 4, wherein, as the brake pressure p increases in a first pressure range 16, the vehicle brake 2 feeds in a brake pad 10 by a brake infeed travel d in the direction of the brake disk 22, crossing a release clearance L, with an increase in a friction torque Mᵣ, and, as the brake pressure p increases further in a second pressure range 18, the brake disk 22 is fed in fully and there is a further increase in the friction torque Mᵣ at the vehicle brake 2.

The method has a step 104, according to which the brake infeed travel d as a function of the brake pressure p is detected. According to step 106, the first pressure range 16 is identified on the basis of the detected brake infeed travel d as a function of the brake pressure p. According to step 108, an application pressure pₐ is finally set to a pressure which is within the first pressure range 16. The method furthermore preferably has the step of: checking 110 the set application pressure pₐ during the operation of the vehicle, in particular via at least one test braking operation.

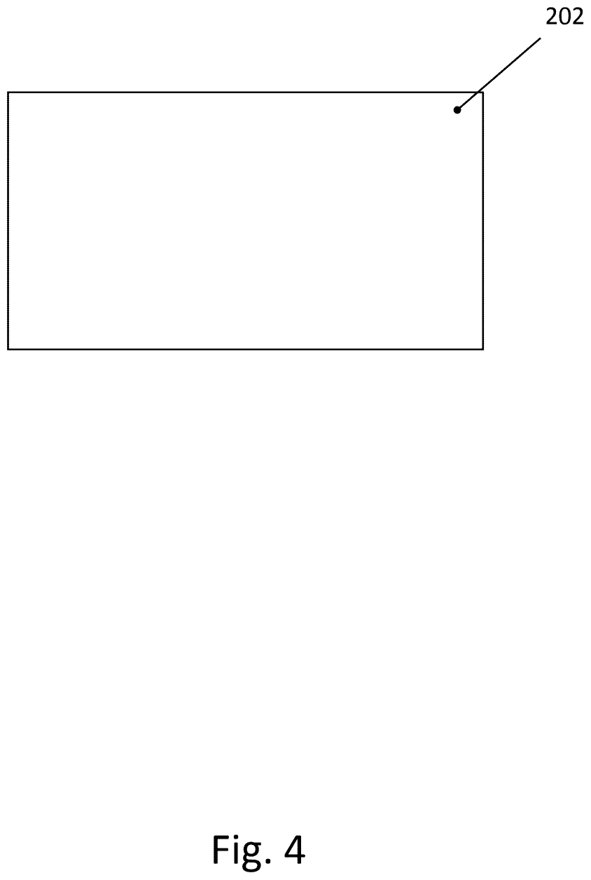

FIG. 4 shows schematically a control device 202 for a vehicle brake 2 of a motor vehicle 1. The control device 202 is configured to carry out the method 100 according to FIG. 3. The control device 202 can be configured as a dedicated control device 202 or as a central control device 202.

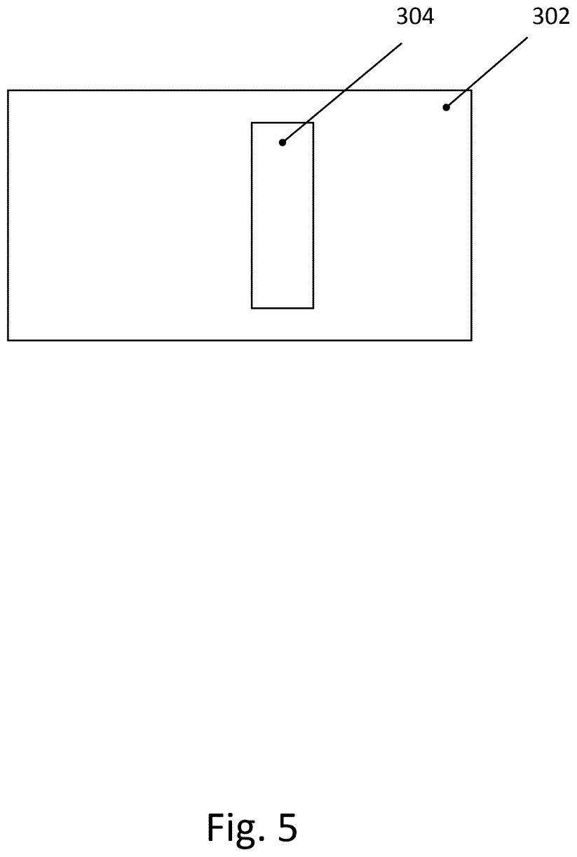

FIG. 5 shows schematically a computer program 302. The computer program product 302 contains commands 304. When executed on a computer (not shown), the commands 304 cause the computer to form a control device 202 according to FIG. 4 and/or to carry out the method 102 according to FIG. 3.

It is understood that the foregoing description is that of the preferred embodiments of the invention and that various changes and modifications may be made thereto without departing from the spirit and scope of the invention as defined in the appended claims.

### LIST OF REFERENCE SIGNS (PART OF THE DESCRIPTION)

1 Motor vehicle
2 Vehicle brake
3 Commercial vehicle
4 Commercial vehicle disk brake
6 Brake carrier
8 Brake pad receptacle
10 Brake pad
12 Brake caliper
14 Measuring arrangement
16 First pressure range
18 Second pressure range
19 Static range
20 Pad wear sensor
22 Brake disk
24 Lower third
26 Middle third
28 Upper third
102 Setting method
104 Detecting the brake infeed travel as a function of the brake pressure
106 Identifying the first pressure range
108 Setting an application pressure to a pressure value within the first pressure range
110 Checking the set application pressure via test braking
202 Control device
302 Computer program product
304 Commands
b Total range width of the first pressure range
d Brake infeed travel
L Release clearance
Mᵣ Friction torque
d Brake pressure
pₐ Application pressure

1. A method for setting an application pressure of a vehicle brake of a motor vehicle having a vehicle disk brake, wherein, as the brake pressure increases in a first pressure range, the vehicle brake feeds in a brake pad by a brake infeed travel in the direction of a brake disk, crossing a release clearance, with an increase in a friction torque, and, as the brake pressure increases further in a second pressure range, the brake disk is fed in fully and there is a further increase in the friction torque at the vehicle brake; the method comprising the steps of:
detecting the brake infeed travel as a function of the brake pressure;
identifying the first pressure range on the basis of the detected brake infeed travel as a function of the brake pressure; and,
setting an application pressure of the vehicle brake to a pressure lying within the first pressure range.

2. The method of claim 1, wherein detection of the brake infeed travel as a function of the brake pressure is performed via a continuous pad wear sensor arranged on the vehicle brake.

3. The method of claim 1, wherein the application pressure is set to a pressure which is in a lower third in relation to a total range width of the first pressure range.

4. The method of claim 1, wherein the application pressure is set to a pressure which is in a middle third in relation to a total range width of the first pressure range.

5. The method of claim 1, wherein the application pressure is set to a pressure which is in an upper third in relation to a total range width of the first pressure range.

6. The method of claim 1, comprising the further step of checking the set application pressure during operation of the vehicle via at least one test braking operation.

7. The method of claim 6, wherein the checking of the application pressure is performed with an aid of an electric vehicle drive by determining i) a change in a drive power; or ii) a change in a drive torque while the at least one test braking operation is being carried out.

8. A control device for carrying out a method for setting an application pressure of a vehicle brake of a commercial motor vehicle having a vehicle disk brake, wherein, as the brake pressure increases in a first pressure range, the vehicle brake feeds in a brake pad by a brake infeed travel in the direction of a brake disk, crossing a release clearance, with an increase in a friction torque, and, as the brake pressure increases further in a second pressure range, the brake disk is fed in fully and there is a further increase in the friction torque at the vehicle brake; the control device comprising:
a non-transitory computer readable medium having a program code stored thereon;
said program code being configured, when executed by processor, to perform the steps of:
detecting a brake infeed travel as a function of a brake pressure;
identifying a first pressure range on the basis of the detected brake infeed travel as a function of the brake pressure; and,
setting an application pressure of the vehicle brake to a pressure lying within the first pressure range.

9. The control device of claim 8, wherein the control device is configured as a dedicated control device or as a central control device.

10. A computer program product containing commands that, when they are executed on a computer, cause the computer to form a control device for carrying out a method for setting an application pressure of a vehicle brake of a commercial motor vehicle having a vehicle disk brake, wherein, as the brake pressure increases in a first pressure range, the vehicle brake feeds in a brake pad by a brake infeed travel in the direction of a brake disk, crossing a release clearance, with an increase in a friction torque, and, as the brake pressure increases further in a second pressure range, the brake disk is fed in fully and there is a further increase in the friction torque at the vehicle brake; the computer program product comprising:
a non-transitory computer readable medium having a program code stored thereon;
said program code being configured, when executed by a processor, to perform the steps of:
detecting a brake infeed travel as a function of a brake pressure;
identifying a first pressure range on the basis of the detected brake infeed travel as a function of the brake pressure; and,
setting an application pressure of the vehicle brake to a pressure lying within the first pressure range.

11. A vehicle brake including a commercial vehicle disk brake, the vehicle brake comprising:
a brake carrier having at least one brake pad receptacle;
at least one brake pad guided and supported in such a way that it can be moved axially in the brake pad receptacle;
a brake caliper that can be moved axially relative to the brake carrier; and,
a measuring arrangement, which is configured to detect a brake infeed travel of the vehicle brake as a function of the brake pressure;
wherein, as the brake pressure increases in a first pressure range, the vehicle brake feeds in a brake pad by a brake infeed travel in the direction of the brake disk, crossing a release clearance, with an increase in a friction torque; and,
as the brake pressure increases further in a second pressure range, the brake disk is fed in fully and there is a further increase in the friction torque at the vehicle brake; and,
the vehicle brake is configured to set an application pressure to a pressure which is within the first pressure range.

12. The vehicle brake of claim 11, wherein the measuring arrangement has a pad wear sensor configured to detect the brake infeed travel of the vehicle brake as a function of the brake pressure.

13. The vehicle brake of claim 11, wherein the application pressure is set to a pressure which is in a lower third in relation to a total range width of the first pressure range.

14. The vehicle brake of claim 11, wherein the application pressure is set to a pressure which is in a middle third in relation to a total range width of the first pressure range.

15. The vehicle brake of claim 11, wherein the application pressure is set to a pressure which is in an upper third in relation to the total width of the first pressure range.

16. A motor vehicle including a commercial vehicle, comprising at least one vehicle brake, wherein the at least one vehicle brake includes:
a brake carrier having at least one brake pad receptacle;
at least one brake pad guided and supported in such a way that it can be moved axially in the brake pad receptacle;
a brake caliper that can be moved axially relative to the brake carrier; and,
a measuring arrangement, which is configured to detect a brake infeed travel of the vehicle brake as a function of the brake pressure;
wherein, as the brake pressure increases in a first pressure range, the at least one vehicle brake feeds in a brake pad by a brake infeed travel in the direction of the brake disk, crossing a release clearance, with an increase in a friction torque; and,
as the brake pressure increases further in a second pressure range, the brake disk is fed in fully and there is a further increase in the friction torque at the at least one vehicle brake; and,
the at least one vehicle brake is configured to set an application pressure to a pressure which is within the first pressure range.

17. The motor vehicle of claim 16, further comprising a control device for carrying out a method for setting an application pressure of a vehicle brake of a commercial motor vehicle having a vehicle disk brake, wherein, as the brake pressure increases in a first pressure range, the vehicle brake feeds in a brake pad by a brake infeed travel in the direction of a brake disk, crossing a release clearance, with an increase in a friction torque, and, as the brake pressure increases further in a second pressure range, the brake disk is fed in fully and there is a further increase in the friction torque at the vehicle brake; the control device including:
a non-transitory computer readable medium having a program code stored thereon;
said program code being configured, when executed by processor, to perform the steps of:
detecting a brake infeed travel as a function of a brake pressure;
identifying a first pressure range on the basis of the detected brake infeed travel as a function of the brake pressure; and,
setting an application pressure of the vehicle brake to a pressure lying within the first pressure range.
